(19) United States
(12) Patent Application Publication
(10) Pub. No.: US 2008/0095874 A1
(43) Pub. Date: Apr. 24, 2008

(54) Device for extruding hollow strands

(76) Inventors: Brigitte Diekhaus, Bielefeld (DE); Jorg Schmuhl, Wusterhausen (DE); Reinhard Klose, Rinteln (DE)

Correspondence Address: SHLESINGER , ARKWRIGHT & GARVEY LLP, 1420 King Street , Suite 600, Alexandria, VA, 22314, US

(21) Appl. No.: 11/907,164

(22) Filed: Oct. 10, 2007

(30) Foreign Application Priority Data
Oct. 18, 2006 (DE) 10 2006 049 660

(51) Int. Cl. B29C 47/90

(52) U.S. Cl. 425/72.1; 425/141

(57) ABSTRACT

Device for extruding hollow strands from thermoplastic material, with an extrusion die and a calibrating device, arranged between which is a mold chamber with an outer mold body for influencing the diameter of a hot, still moldable hollow strand emerging from an annular die of the extrusion die. The device is configured for extruding hollow strands of thermoplastic material and with which changing the wall thickness of the hollow strand emerging from the annular die is also possible. This is achieved by the mold chamber having an inner mold body, the inner and outer mold bodies being arranged coaxially in relation to the annular die and, by axial and/or radial adjustment in relation to each other, forming an annular gap between them for changing the cross section and/or the wall thickness of the hollow strand emerging from the annular die.

### CROSS-REFERENCE TO RELATED APPLICATION

This application claims the priority of German application no. 10 2006 049 660.4, filed Oct. 18, 2006, and which is incorporated herein by reference.

### FIELD OF THE INVENTION

The present invention relates to a device for extruding hollow strands from thermoplastic material.

### BACKGROUND OF THE INVENTION

In EP 1 115 551 B1, a description is given of a device for producing plastic pipes in which a vacuum chamber fitted with measuring instruments for recording the outer diameter of the pipe is arranged between the pipe extrusion head and the calibrating device. These measuring instruments control the negative pressure prevailing in the vacuum chamber in dependence on the desired outer diameter of the pipe, i.e. the extruded pipe, in the plastic state, is enlarged to the desired outer diameter by suction. The extrusion die of this known device has an adjustable annular gap, with which it is possible in conjunction with the vacuum chamber to set an exact pipe wall thickness, which can also be varied in dependence on the outer pipe diameter.

DE 202 19 089 U1 likewise describes a device with a vacuum chamber provided between the extrusion die and the calibrating device. This vacuum chamber corresponds substantially to that of EP 1 115 551 B1. As a difference from it, the wall of the vacuum chamber is perforated, so that a cooling medium can be made to pass through its wall to the outside of the pipe.

A device of the generic type is disclosed by DE 20 2004 019 566 U1. In the case of this device, the hollow strand coming from the extrusion die runs into a guiding chamber, which has guiding rings that are fastened on spacing pins and the inner diameter of which increases continuously in the direction of extrusion. The inner diameters of the guiding rings thereby form defined detachment edges for the hollow strand. The outlet of the guiding chamber directly adjoins the inlet of the calibrating device. The hollow strand is consequently safely guided between the extrusion die and the calibrating device, and transferred to the latter in the appropriate format. In order to assist the application of the hollow strand to the guiding rings, a vacuum may be applied to the guiding chamber. Influencing of the wall thickness of the hollow strand emerging from the annular die of the extrusion die is not possible with this guiding chamber.

### OBJECTS AND SUMMARY OF THE INVENTION

An object of the present invention is to provide a device of the generic type for extruding hollow strands of thermoplastic material with which changing the wall thickness of the hollow strand emerging from the annular die is also possible.

This object is achieved according to the invention as set forth herein.

This object is likewise achieved by the inventive device for extruding hollow strands from thermoplastic material, the device including an extrusion die and a calibrating device, arranged between which is a mold chamber with an outer mold body for influencing the diameter of a hot, still moldable hollow strand emerging from an annular die of the extrusion die. The mold chamber has an inner mold body, and the inner and outer mold bodies are arranged coaxially in relation to the annular die and, by one of axial and radial adjustment in relation to each other, form an annular gap between them for changing one of the cross section and the wall thickness of the hollow strand emerging from the annular die, in use.

The device according to the invention is intended in particular for use on extrusion lines with which a dimensional change can be made while production is in progress. It can be used with advantage in the case of new investments but is also suitable for retrofits.

With the device according to the invention, the hollow strand emerging from the annular die of the extrusion die can be subsequently changed in its wall thickness and is cross section in the sense of an enlargement or reduction, so that a dimensional change while production is in progress is possible on a correspondingly equipped extrusion line. Axial and/or radial adjustment of the outer mold body and the inner mold body in relation to each other has the effect that a changeable annular gap is formed between them, by which the extruded hollow strand can be influenced in its dimensions in adaptation to the setting of the calibrating device.

Further advantageous refinements of the invention are provided by the subclaims.

The invention is explained in more detail below on the basis of exemplary embodiments of a pipe extrusion line.

Relative terms such as left, right, up, and down are for convenience only and are not intended to be limiting.

### BRIEF DESCRIPTION OF THE DRAWINGS

FIG. 1 shows a schematic side view of an extrusion line,

FIG. 2 shows an enlarged schematic detail A according to FIG. 1 as provided by a first embodiment of the invention,

FIG. 3 shows a representation of the device according to FIG. 2 in a first operating state,

FIG. 4 shows a representation of the device according to FIG. 2 in a second operating state,

FIG. 5 shows an enlarged, schematic detail A according to FIG. 1 as provided by a second embodiment of the invention,

FIG. 6 shows a representation of the device according to FIG. 5 in a first operating state,

FIG. 7 shows a representation of the device according to FIG. 5 in a second operating state,

FIG. 8 shows an enlarged, schematic detail A according to FIG. 1 as provided by a third embodiment of the invention in a first operating state,

FIG. 9 shows a representation of the device according to FIG. 8 in a second operating state,

FIG. 10 shows an enlarged schematic representation of the outer mold body of the third embodiment,

FIG. 11 shows an enlarged, schematic detail (A) according to FIG. 1 as provided by a fourth embodiment of the invention in a first operating state,

FIG. 12 shows a representation of the device according to FIG. 11 in a second operating state,

FIG. 13 shows a schematic plan view of the outer mold body in the first operating state, and

FIG. 14 shows a representation according to FIG. 13 in the case of the outer mold body in the second operating state.

### DETAILED DESCRIPTION OF THE INVENTION

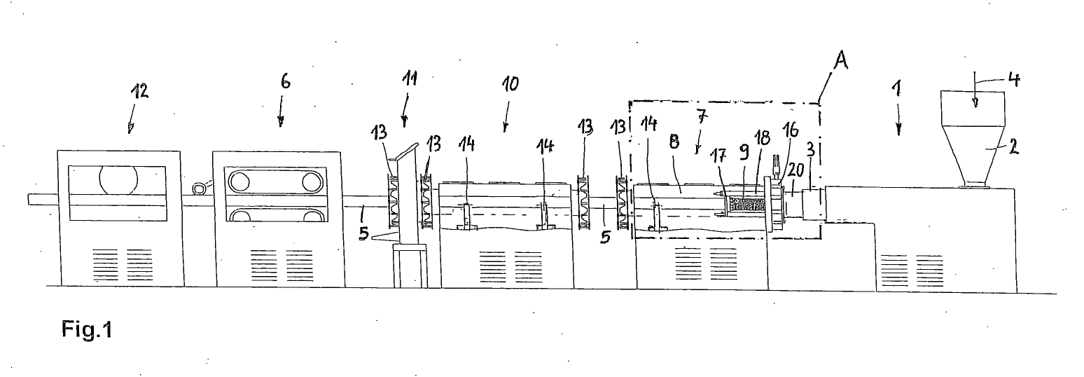

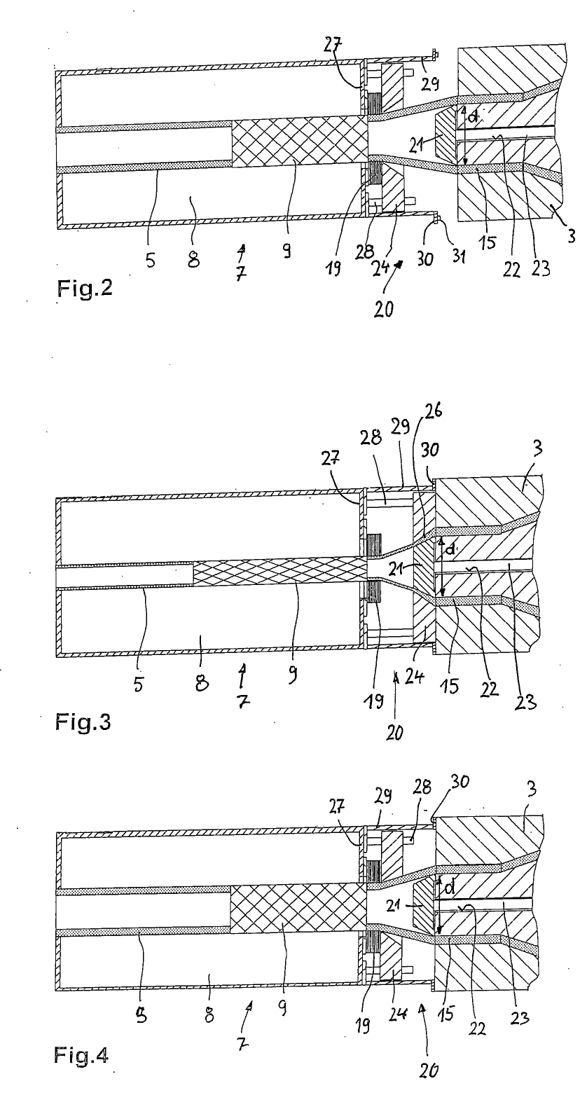

The extrusion line for producing pipes that is represented in FIG. 1 comprises an extruder unit 1 with a feed hopper 2, an extruder screw, which cannot be seen in the drawing, and a pipe extrusion head 3. A thermoplastic material 4 in the form of granules or powder is fed to the extruder unit 1 via the feed hopper 2. In this extruder unit, the granules or powder is/are heated, kneaded and plasticated. Subsequently, the plastic 4 is conveyed as a moldable compound by the extruder screw into the pipe extrusion head 3 and forced there through an annular die 15 (see FIGS. 2 to 9).

After emerging from the annular die 15, the hot, still deformable pipe 5 is drawn by means of a caterpillar take-off unit 6, arranged at the end of the extrusion line, through a calibrating and cooling unit 7, which has a vacuum tank 8 with a calibrating sleeve 9 arranged at its inlet. The calibrating sleeve 9 is infinitely variable in diameter, so that the extruded, still moldable pipe 5 can be fixed to the desired outer diameter. After leaving the calibrating and cooling unit 7, the pipe 5 enters a cooling zone 10, in which it is cooled down to room temperature. Arranged between the cooling zone 10 and the caterpillar take-off unit 6 is an ultrasonic scanner 11, with which the diameter and the wall thickness of the extruded pipe 5 are recorded. The caterpillar take-off unit 6 is adjoined by a separating saw 12, in which the pipe 5 is cut to length. To maintain a negative pressure in the calibrating and cooling unit 7, the cooling zone 10 and the ultrasonic scanner 11, seals 13 are provided, enclosing the pipe 5 running through with a sealing effect.

Since the extruded pipe 5 is only cured, i.e. becomes dimensionally stable, after it leaves the cooling zone 10, before that it must be supported to avoid it sagging and thereby deforming. For this purpose, two pipe supports 14 are provided in the cooling zone 10 and one is provided in the calibrating and cooling unit 7.

The calibrating sleeve 9 has an annular inlet head 16 and an annular outlet head 17. While the inlet head 16 is arranged outside the vacuum tank 8, the outlet head 17 is in the vacuum tank 8 (FIG. 1). The outlet head 17 has a fixed inner diameter, which corresponds at least to the greatest pipe diameter to be handled in the extrusion installation. It can be displaced with respect to the fixed inlet head 16 in the axial direction of the calibrating sleeve 9, in order to change its diameter. For this purpose, at least two spindle units 18 are provided, the threaded spindles of which are motor-driven.

The inlet head 16 has radially adjustable segments 19 (FIGS. 2 to 9), which are arranged uniformly over the circumference of the pipe 5 to be calibrated. For the further construction of the calibrating sleeve 9, reference is made to DE 2005 002 820 B3, the relevant disclosure of which is hereby made the subject matter of these exemplary embodiments; i.e., which is incorporated herein by reference. This calibrating sleeve 9, in the same way as the other equipment of the extrusion line too, is suitable for making a dimensional change while production is in progress.

Provided between the pipe extrusion head 3 and the calibrating sleeve 9 is a mold chamber 20 for influencing the dimensions, i.e. for changing the wall thickness and the diameter, of the plasticated pipe 5 emerging from the annular die 15, which is explained in more detail below in exemplary embodiments on the basis of FIGS. 2 to 10. In these schematic representations, for the sake of overall clarity, all that is shown of the adjusting devices of the calibrating sleeve 9 are segments 19 of the inlet head 16.

First, the features that are common to the exemplary embodiments according to FIGS. 2 to 7 are explained.

Belonging to the mold chamber 20 is a mold plug 21 of circular cross section, which forms the inner mold body, tapers conically in the direction of production and the greatest diameter of which corresponds to the inner diameter d of the annular die 15. The mold plug 21 is arranged coaxially in relation to the annular die 15 and is guided in an axially displaceable manner in a central bore 22 of the annular die 15 by means of a holding bar 23. A corresponding drive is not represented.

The mold plug 21 works together with a mold ring 24, which forms the outer mold body and is likewise arranged coaxially in relation to the annular die 15. The mold ring 24 has a rigid opening 25, tapering in the direction of production. If the mold ring 24 and the mold plug 21 are congruent (FIGS. 3, 7), they form an annular gap 26 with a diameter reducing in the direction of production, and a reducing gap width, between them.

The mold ring 24 is mounted on holding bars 28 protruding axially from an end wall 27 of the vacuum tank 8 and can be axially displaced on the holding bars 28 by means of a drive (not represented).

In the exemplary embodiment according to FIGS. 2 to 4, the mold chamber 20 is closed at the circumference by a casing 29, which is likewise fastened to the end wall 27 of the vacuum tank 8. At its end remote from the end wall 27, the casing 29 has a peripheral flange ring 30 with a peripheral end seal 31. For closing the mold chamber 20, the vacuum tank 8 is moved in the axial direction, until the end seal 31 lies against the pipe extrusion head 3 with a sealing effect (FIGS. 3, 4).

In the operating state shown in FIG. 3, the mold plug 21 has been brought into contact with the pipe extrusion head 3 and the mold ring 24 has been made congruent with the mold plug 21. The calibrating sleeve 9 has been set to its smallest diameter. With this setting, pipes 5 with a small diameter and small wall thickness can be produced.

In the operating state according to FIG. 4, the mold plug 21 still lies against the pipe extrusion head 3, and the mold ring 24 has been brought up against the segments 19 of the inlet head 16 of the calibrating sleeve 9. The calibrating sleeve 9 has been set to its greatest diameter. In this operating state, the plasticated hollow strand 5 emerging from the annular die 15 remains uninfluenced by the mold chamber 20. With this setting, pipes 5 with a large diameter and large wall thickness are produced.

With the operating states shown in FIGS. 3 and 4, pipes 5 of intermediate sizes (diameter and wall thickness) can also be produced, by the mass throughput being varied in a coordinated manner by the annular die 15 of the pipe extrusion head 3 and/or the take-off rate of the extruded pipe 5 on the extrusion line. The calibrating sleeve 9 is then correspondingly opened or closed further. In addition or as an alternative to this, the diameter and the wall thickness of the pipe 5 produced may also be influenced by axially moving the mold plug 21 and the mold ring 24. This produces optimum conditions for making a dimensional change while production is in progress.

On account of the closed configuration of the mold chamber 20 in the operating state, a negative pressure can be produced in it, whereby the sealing of the extruded pipe 5 at the segments 19 of the inlet head 16 of the calibrating sleeve 9 is improved.

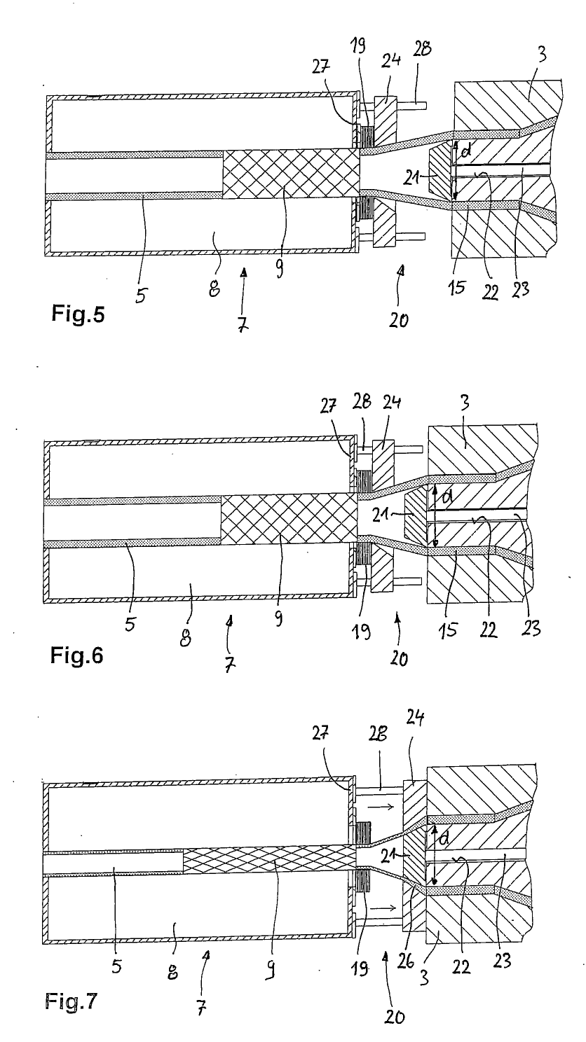

The exemplary embodiment according to FIGS. 5 to 7 differs from that explained above in that the mold chamber 20 is open, that is to say does not have a surrounding casing 29. Here, the sealing between the extruded pipe 5 and the segments 19 of the inlet head 16 of the calibrating sleeve 9 can be improved by blowing in supporting air, for example through the mold plug 21. At the same time, this can compensate for a negative pressure possibly occurring in the pipe 5.

In exemplary embodiments, the mold ring 24 and the mold plug 21 can be heated if need be. Furthermore, the mold plug 21 and the mold ring 24 may have a surface with a low friction coefficient, at least at the areas in contact with the pipe 5.

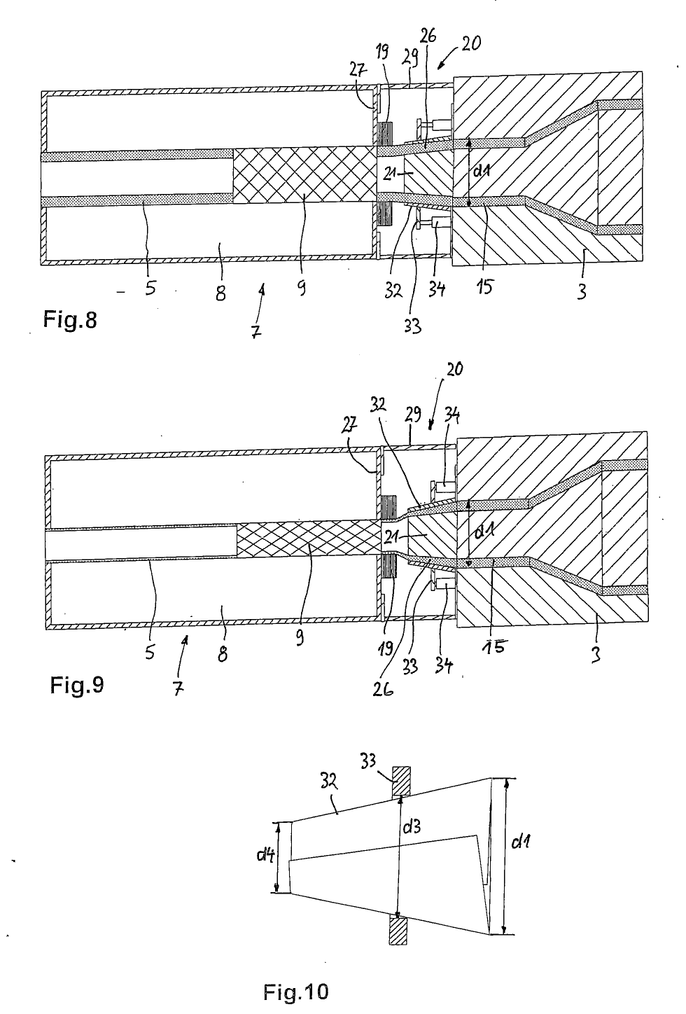

In the exemplary embodiment represented in FIGS. 8 to 10, as in the exemplary embodiment according to FIGS. 2 to 4, the mold chamber 20 again likewise has a circumferential wall 29, to create a closed configuration for the application of a vacuum. In the case of this exemplary embodiment, however, the mold chamber 20 may also be of an open configuration, as in the case of the exemplary embodiment according to FIGS. 5 to 7.

The inner mold body is here in turn configured with a circular cross section, tapering in the direction of production, its greatest diameter, towards the pipe extrusion head 3, corresponding to the inner diameter d of the annular die 15. The mold plug 21 is shown stationary in FIGS. 8 and 9. However, as in the case of the previous exemplary embodiments, it may also be of an axially and/or radially adjustable configuration. Furthermore, heating of the mold plug 21 may be provided.

The outer mold body is formed from a thin, flexible metal sheet, which is rolled up in such a way as to obtain a cone 32, as can best be seen from FIG. 10. The material of this metal sheet is chosen such that the cone 32 has adequate inherent rigidity and recovery (elasticity). The cone 32 tapers in the direction of production, its greatest diameter d1 corresponding to the outer diameter of the annular die 15. The cone 32 is fixed at this end, so that its diameter d1 is unchangeable.

For the adjustment of the cone 32, an adjusting ring 33 with a fixed inner diameter d3 is provided. This adjusting ring 33 is mounted on the pipe extrusion head 3 by means of guides 34 and is axially displaceable by a drive (not represented).

In the operating state shown in FIG. 8, the calibrating sleeve 9 has been set to its greatest diameter and the adjusting ring 33 has been axially displaced to the maximum in the direction of production. As a result, the smallest diameter d4 of the cone 32 assumes its greatest value, which substantially corresponds to the inlet diameter of the segments 19 of the inlet head 16 of the calibrating sleeve 9. With this setting, pipes 5 with a large diameter and large wall thickness are produced.

In the operating state according to FIG. 9, the adjusting ring 33 has been moved to the maximum up against the pipe extrusion head 3, so that the smallest diameter d4 of the cone 32 assumes its smallest value. As a result, the diameter of the extruded pipe 5 and its wall thickness change at the same time in the sense of a reduction. In the case of the operating state according to FIG. 9, pipes with the smallest diameter are produced. Corresponding intermediate stages can be produced by changing the conicity of the cone 32, the variability of the system being further increased with axial and/or radial adjustability of the mold plug 21.

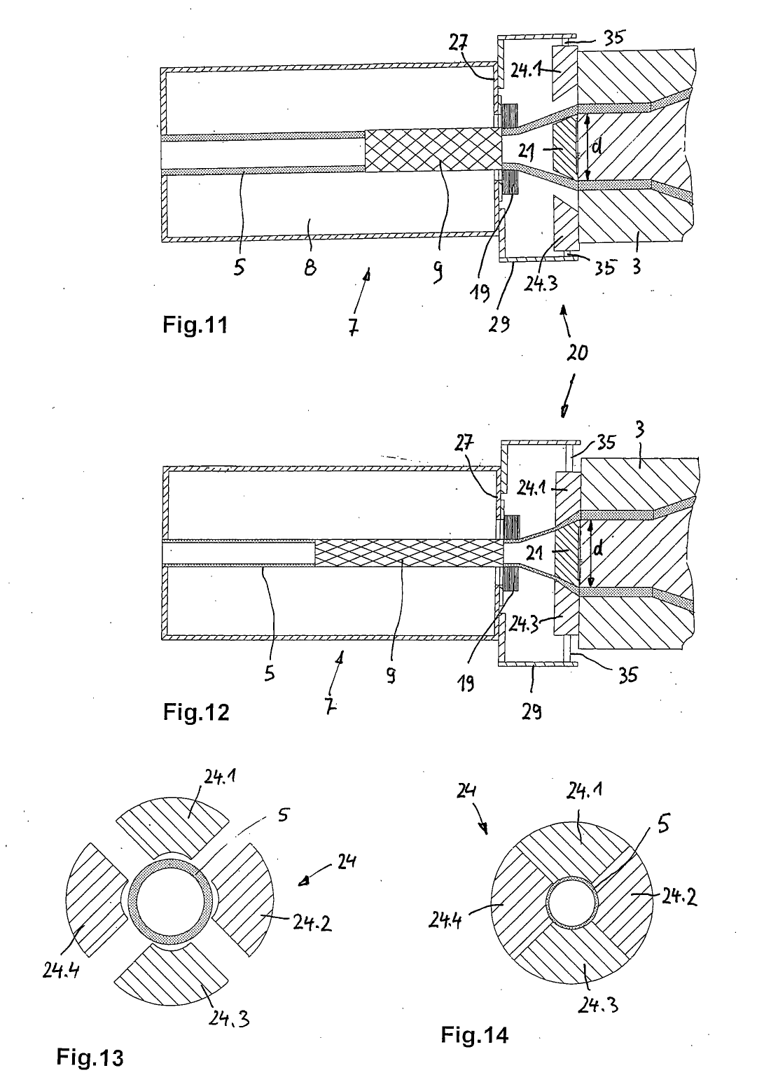

In the exemplary embodiment represented in FIGS. 11 to 14, although the mold chamber 20 has a circumferential wall 29, it is not closed. In the case of this exemplary embodiment, however, the mold chamber 20 may also be of a closed configuration, as in the case of the exemplary embodiments according to FIGS. 2 to 4 and 8 to 10.

The inner mold body is here in turn configured as mold plug 21 with a circular cross section, tapering in the direction of production, its greatest diameter, towards the pipe extrusion head 3, corresponding to the inner diameter d of the annular die 15. The mold plug 21 is fastened to the pipe extrusion head 3 in a stationary manner.

Also in the case of this exemplary embodiment, the mold plug 21 works together with a mold ring 24, which forms the outer mold body and is likewise arranged coaxially in relation to the annular die 15. It comprises four segments 24.1 to 24.4, which are radially adjustable on holding bars 35 protruding inwards from the casing 29 of the mold chamber 20 by means of a drive (not represented).

In this exemplary embodiment, the four segments 24.1 to 24.4 of the mold ring 24 are identically configured. That is not necessary, however. Similarly, the parts of the mold ring 24 may be differently configured and be made up of fewer or more than four parts. What is essential is that, when the individual parts of the mold ring 24 are moved radially together, as represented by way of example in FIG. 14, an annular gap 26 with a diameter reducing in the direction of production, and a reducing gap width, is formed between the mold ring 24 and the mold plug 21.

In the operating state shown in FIGS. 11 and 13, the segments 24.1 to 24.4 of the mold ring 24 have been moved radially apart and the calibrating sleeve 9 has been set to its greatest diameter. In this operating state, the plasticated hollow strand 5 emerging from the annular die 15 remains uninfluenced by the mold chamber 20. With this setting, pipes 5 with a large diameter and large wall thickness are produced.

In the operating state according to FIGS. 12 and 14, the segments 24.1 to 24.4 of the mold ring 24 have been moved radially together, so that a tapering through-gap for the plasticated hollow strand 5 is obtained between the mold ring 24 and the mold plug 21. The calibrating sleeve 9 has been set to its smallest diameter. With this setting, pipes 5 with a small diameter and small wall thickness can be produced.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for extruding hollow strands from thermoplastic material, comprising:
a) an extrusion die and a calibrating device, arranged between which is a mold chamber with an outer mold body for influencing the diameter of a hot, still moldable hollow strand emerging from an annular die of the extrusion die;
b) the mold chamber having an inner mold body; and
c) the inner and outer mold bodies being arranged coaxially in relation to the annular die and, by one of axial and radial adjustment in relation to each other, forming an annular gap between them for changing one of the cross section and the wall thickness of the hollow strand emerging from the annular die, in use.

2. Device according to claim 1, wherein:
a) one of the inner mold body and the outer mold body is heatable.

3. Device according to claim 2, wherein:
a) the mold chamber is closed and can be subjected to a vacuum.

4. Device according to claim 1, wherein:
a) the mold chamber is closed and can be subjected to a vacuum.

5. Device according to claim 2, wherein:
a) the mold chamber includes a device configured for blowing supporting air into the extruded hollow strand.

6. Device according to claim 1, wherein:
a) the mold chamber includes a device configured for blowing supporting air into the extruded hollow strand.

7. Device according to claim 6, wherein:
a) the extruded hollow strand includes an extruded pipe.

8. Device according to claim 6, wherein:
a) one of the inner mold body and the outer mold body has a surface with a low friction coefficient.

9. Device according to claim 1, wherein:
a) one of the inner mold body and the outer mold body has a surface with a low friction coefficient.

10. Device according to claim 9, wherein:
a) the inner mold body includes a mold plug with a cross section tapering in the direction of production.

11. Device according to claim 1, wherein:
a) the inner mold body includes a mold plug with a cross section tapering in the direction of production.

12. Device according to claim 1, wherein:
a) the outer mold body is a mold ring with an opening tapering in the direction of production.

13. Device according to claim 1, wherein:
a) the outer mold body is a cone, which is a rolled up thin elastic metal sheet, and a greatest diameter of which is radially and axially fixed, and a smallest diameter of which is radially adjustable.

14. Device according to claim 13, wherein:
a) an adjusting ring lying against the outer circumference of the cone is provided, and by the axial adjustment of which adjusting ring changing of the conicity of the cone can be achieved.

15. Device according to claim 14, wherein:
a. the mold chamber is fixed to the vacuum tank and can be adjusted together with it towards the extrusion die.
